(19) United States
(12) Patent Application Publication
(10) Pub. No.: US 2009/0151570 A1
(43) Pub. Date: Jun. 18, 2009

(54) CRANKCASE VENTILATION FILTER/PRE-SEPARATOR

(76) Inventors: Ronald G. Frazier, JR., Oxford, MS (US); David Tice, Michigan City, MS (US)

Correspondence Address: CHRISTOPHER H. HUNTER, PARKER-HANFIN CORPORATION, 6035 PARKLAND BOULEVARD, CLEVELAND, OH, 44124-4141, US

(21) Appl. No.: 12/334,072

(22) Filed: Dec. 12, 2008

Related U.S. Application Data
(60) Provisional application No. 61/013,451, filed on Dec. 13, 2007.

(51) Int. Cl. F02M 35/024

(52) U.S. Cl. 96/189

(57) ABSTRACT

A filter for removing liquid contaminants from a fluid stream. The filter includes a housing with an internal chamber and inlet and outlet ports. A sump with a drain port is located intermediate the inlet and outlet ports. Expanded aluminum filter media in bunched form is located in the chamber and can be inserted through the inlet port. A support disc supports the downstream end of the filter media at a predetermined axial location within the chamber, and has an aperture allowing contaminant-free gas flow downstream to the outlet port. The liquid contaminants and emission particles are separate by the filter media and agglomerate for collection in the sump and for draining through the drain port, while the support disc prevents the liquid contaminants from migrating downstream along the walls of the housing.

### CROSS-REFERENCE TO RELATED CASES

The present application claims the benefit of the filing date of U.S. Patent Application Ser. No. 61/013,451, filed Dec. 13, 2007, the disclosure of which is fully incorporated herein by reference.

### FIELD OF THE INVENTION

The present invention is directed toward a crankcase ventilation filter for diesel or gas engines.

### DETAILED DESCRIPTION OF THE INVENTION

Emission controls for internal combustion engines have become increasingly important as concerns over the environment have risen. One area where improvement has been noted is in crankcase emission controls.

Crankcase emissions result from gas escaping past the piston rings of an internal combustion engine and entering the crankcase due to high pressure in the cylinders during compression and combustion. As the blow-by gas passes through the crankcase and out the breather, the breather becomes contaminated with oil mist. The gas also contains wear particles and air/fuel emissions. In closed systems, the crankcase emissions are directed into the engine intake system causing internal engine contamination and loss of efficiency.

The oily crankcase emissions coat engine sites, such as the inside of engine compartments or chambers, fouling expensive components and increasing costs, such as clean-up, maintenance and repair costs. As the oily residue builds up on critical engine components, such as radiator cores, turbocharger blades, intercoolers and air filters, the residue becomes a “magnet” for dust, grit and other airborne contaminants. The accumulation of contaminants on these components reduces efficiency, performance and reliability of the engine.

Crankcase emission control systems filter the crankcase particulate emissions and separate the oil mist from the crankcase fumes. The separated oil is collected for periodic disposal or returned to the crankcase. Since most of the crankcase particulate emissions are soluble hydrocarbons, returning the cleaned, oil-free crankcase emissions to the engine inlet increases engine efficiency.

One particularly useful crankcase emission control system is shown in U.S. Pat. No. 5,564,401, owned by the assignee of the present invention. In this system, a high efficiency filter and crankcase pressure regulator are combined into a single unit connected between the engine crankcase breather and the engine air intake. The filter separates small sized particles to prevent contamination of turbochargers, the aftercooler, and internal engine components. The pressure regulator maintains acceptable levels of crankcase pressure over a wide range of crankcase gas flow and inlet restrictions.

In the aforementioned system, the pressure control assembly is located in a housing body and is configured to regulate pressure through the system as well as agglomerate particles suspended in the blow-by gasses. Inlet and outlet ports direct the blow-by gasses into and out of the housing body from the engine block. A filter housing enclosing a replaceable filter is removably attached to the housing body to separate any remaining oil from the blow-by gasses. The filter element can be easily removed from the filter housing for replacement, after removing the filter housing from the housing body. The oil drains down and collects in a reservoir at the bottom of the filter housing. An oil drain check valve is located in the bottom wall of the filter housing, and includes a free-floating (one-way) check valve. The check valve is connected through a separate return line to the oil pan or engine block to return the collected oil to the engine.

Another useful crankcase emission control system is shown in U.S. Pat. No. 6,561,171, also owned by the assignee of the present invention, In this system a compact filter assembly is mounted within with the cylinder head of the engine. The assembly does not require costly modification to the cylinder head cover; and allows collected oil to easily return to the engine during operation and/or after shutdown.

While the above-described crankcase emission control systems offer significant advantages in removing particles from the blow-by gasses, there is believed a need in particular applications for very simple, compact and inexpensive crankcase emission control system, and in particular for a simple, compact and inexpensive system that effectively removes oil droplets from engine crankcase emissions during engine operation.

### SUMMARY OF THE PRESENT INVENTION

The present invention provides a novel and unique crankcase emissions control system. The crankcase emission control system comprises a filter having a molded housing enclosing filter media which removes oil entrained in a gas stream, and allows collected oil to easily return to the engine. The filter media can be easily assembled with the housing to provide a compact, inexpensive system that is easily attachable within the fuel system, and is removable and replaceable once the filter media becomes spent.

According to the present invention, the filter includes a housing adapted to be connected within the crankcase emissions flow path from an engine. The housing is preferably molded as a single, unitary piece, from a material such as plastic or other high-temperature polymer such as glass-filled nylon, and includes inlet and outlet ports at opposite ends of the housing for connection within the gas lines. Simple outwardly, directed radial tabs or a ridge can be formed around the ports to facilitate attaching hoses to the housing.

The housing has an internal, elongated chamber, preferably with smooth, cylindrical internal walls; and a cup-shaped drain sump is formed along the length of the chamber, towards its bottom, and between the inlet and outlet ports. The drain sump includes a drain port, preferably about the midpoint of the sump, and directed downwardly, substantially vertically, from the housing. The drain port also includes outwardly directed radial tabs or a ridge to facilitate connecting the drain port to a return line to the engine.

The filter media preferably comprises an expanded aluminum media, which according to one embodiment is bunched together and can be inserted through the inlet port of the housing into the internal chamber. The rounded internal walls of the housing facilitate the easy insertion of the filter media, and sufficient media is inserted into the housing to remove a desired amount of oil and emission particulate from the exhaust gas, depending on the particular application.

The outlet port end of the housing includes a downstream support device which facilitates the assembly of the filter, and defines the axial location of the filter in the housing. The support device is located downstream of the sump, preferably between the sump and the outlet port of the housing. In one embodiment, the support device could be disc-shaped and could have a circular peripheral configuration, which fits closely within the inner diameter of the housing, and is fixed to the housing such as with adhesive, friction fit, or by other appropriate means. The support device includes in one embodiment a central aperture, which could have a “star-shaped” configuration, that is, with inwardly-projecting portions which facilitate locating and supporting the downstream end of the media.

The support device is preferably formed from material compatible with the housing, the media and the exhaust gas, and is preferably formed of the same molded material as the housing.

When exhaust gas to be cleaned enters the inlet port of the device, the gas impacts the filter media, and oil particles agglomerate and drip downwardly to be caught in the bottom of the housing, and in the sump. Emission particles are also separated from the gases as the gasses pass through the media and retained within the media, or contained within the oil particles. Oil collected around the opening to the sump will generally drain down into the sump due to the pressure of the incoming crankcase emissions.

The collected oil then passes downwardly by gravity through the drain port in the sump, where it can be returned to the engine. The substantially oil and emission-particulate-free gases then continue to pass through the media, through the aperture(s) in the support device, and out through the outlet port in the housing, where the gasses can then be directed to a turbocharger, to atmosphere, to or other appropriate location. In a closed crankcase application, this will prevent oil and contaminants from entering the turbocharger which would cause damage and premature wear to the turbo components. In an open crankcase application, the device will reduce the amount of oil and contaminants which would be exposed to the atmosphere. The result is a cleaner burning and more efficient engine that will benefit the environment.

The emission control system of the present invention could also be used as an impactor or pre-separator to remove oil droplets from engine crankcase emissions/particulates during operation.

Further features of the present invention will become apparent to those skilled in the art upon reviewing the following specification and attached drawings.

### BRIEF DESCRIPTION OF THE DRAWINGS

FIG. 1 is a cross-sectional side view of a filter constructed according to the principles of the present invention;

FIG. 2 is an end view from the inlet end of the filter of FIG. 1;

FIG. 3 is an end view from the outlet end of the filter of FIG. 1; and

FIG. 4 is an elevated perspective view of a further embodiment of the filter of FIG. 1.

### DETAILED DESCRIPTION OF THE PREFERRED EMBODIMENTS

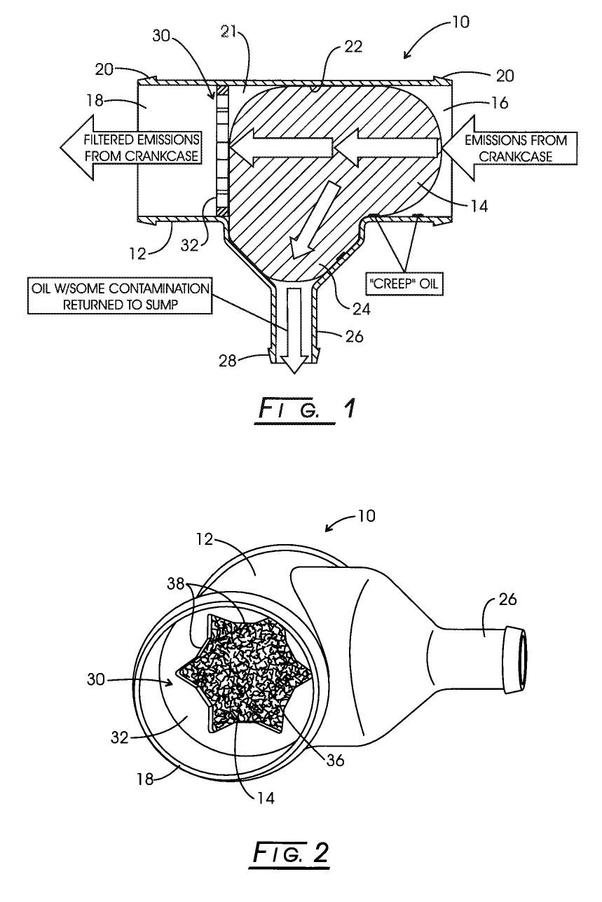

Referring initially to FIG. 1, the crankcase emission control system of the present invention includes a filter indicated generally at 10. The filter 10 includes a molded housing 12 enclosing filter media 14 which removes oil or other liquid contaminants entrained in a gas stream, and allows collected oil to easily return to an engine. The filter media 14 can be easily assembled with the housing 12 as will be described below, to provide a compact, inexpensive filter that is easily attachable within the fuel system, and is removable and replaceable once the filter becomes spent.

According to the present invention, the filter 10 is adapted to be connected within the crankcase emissions flow path from an engine. The housing is preferably molded as a single, unitary piece, from a material such as plastic or other high-temperature polymer such as glass-filled nylon, and includes inlet and outlet ports 16, 18 at opposite axial ends of the housing for connection within the gas lines. Simple outwardly, directed radial tabs as at 20 or a ridge can be formed around the ports to facilitate attaching hoses to the housing, although one or both ports could be connected directly to an engine component. The housing is preferably oriented such that the inlet and outlet ports are horizontally located—that is, gas flows horizontally through the housing.

The housing 12 has an internal, elongated chamber 21 circumscribing a central axis, preferably with smooth, cylindrical internal walls as at 22; and a cup-shaped drain sump 24 is formed along the length of the chamber, towards its bottom, and between the inlet and outlet ports 16, 18. The drain sump is preferably formed unitary in one piece with the housing, and includes a drain port 26, preferably about the midpoint of the sump, and directed downwardly, substantially vertically, from the housing, transverse to the central axis. The drain port 26 is normally smaller than the inlet and outlet ports 16, 18; which themselves are preferably about the same size. The drain port 26 also includes outwardly directed radial tabs as at 28 or a ridge to facilitate connecting the drain port to a return line to the engine.

The filter media 14 preferably comprises an expanded aluminum media, which is bunched together and can be inserted through the inlet port 16 of the housing into the internal chamber 21. One expanded aluminum media appropriate for the present invention is aluminum foil marketed as a consumer product, although expanded aluminum material is available from a number of sources. The media could also be initially in an annular form, and the media can then be sliced or cut as appropriate to fit the opening of the inlet port. Other appropriate media which can be easily inserted into the housing and removes suspended oil from crankcase gases could also be used, as should be appreciated by those skilled in the art. The density of the bunched media can be varied depending on the desired oil and emission particulate removal, and acceptable pressure drop across the system. The rounded internal walls of the housing facilitate the easy insertion of the filter media, and sufficient media is inserted into the housing to remove a desired amount of oil and emission particulate from the exhaust gas, depending on the particular application. In the illustrated embodiment, the media fills up a substantial portion of the housing, is somewhat tightly bunched, and is contained within the cavity of the housing spaced from the inlet port and the outlet port. The media also substantially fills the sump. As illustrated in FIG. 2, the upstream end of the media is self-supporting; although a retaining member, such as a split ring, could be used to retain the upstream end of the media in the housing.

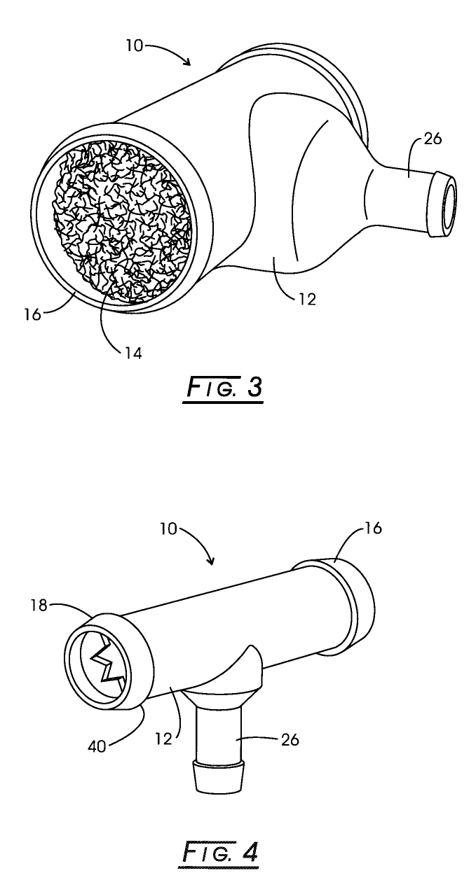

The outlet port end of the housing includes a downstream support device as at 30 which facilitates the assembly of the system, and defines the axial location of the filter media 14 in the housing 12. The support device 30 includes a frame 32 to attach the device to the internal walls 22 of the housing, and includes an open portion, for example, referring now also to FIG. 3, one or more apertures 36, to allow clean gas to flow through the disc and out the outlet port, while preventing collected oil in the lower part of the housing from passing downstream through the outlet port in the housing. In one embodiment, the support device could be disc-shaped and could have a continuous circular peripheral configuration, which fits closely within the inner diameter of the housing, and is fixed to the housing such as with adhesive, friction fit, or by other appropriate means; or formed in one piece with the housing. The disc could also bottom against an inner lip or ridge within the housing and be held there in the aforementioned manner, or by the pressure of the filter media against the disc. In any event, the device includes in one embodiment an outer circular frame and a single central aperture 36, which is illustrated as having a “star-shaped” configuration, that is, with radially inward projecting portions as at 38 which facilitate locating and supporting the downstream end of the media 14.

Other configurations for the support device are of course possible, and again, the device 30 merely has to provide some means of attachment or fixation to the housing 12, some means of retaining the media 14 at the desired location in the housing, some means 7, for preventing migration or drainage of the collected oil through the outlet port, and some means for allowing clean gas to flow out through the outlet port 18 with minimal or otherwise acceptable pressure drop. It is noted that it is preferred to have a circular support disc, as such a circular disc would prevent downstream creep or migration of the oil collected along the bottom of the housing through the outlet port by virtue of the circular frame. As indicated previously, the support device could be a separate component from the housing and fixed or connected thereto; or molded in one piece with the housing toward the outlet end of the housing. In a further embodiment shown in FIG. 4, the support device could be formed as a cap 40 at the outlet end of the housing, where the cap 40 also functions as the outlet port and can be connected to appropriate hoses within the exhaust system.

In any event, the support device 30 is preferably formed from material compatible with the housing, the media and the exhaust gas, and is preferably formed of the same molded material as the housing. The device 30 is located downstream of the sump 24, preferably between the sump 24 and the outlet port 18 of the housing. In the illustrated embodiment the support device has a circular outer periphery with an internal star-shaped aperture, and is supported transversely to the central axis of the housing at a location close to the downstream portion of the sump opening.

When exhaust gas to be cleaned enters the inlet port of the device, the gas impacts the filter media, and oil particles agglomerate and drip downwardly to be caught in the bottom of the housing, and in the sump. Emission particles are also separated from the gases as the gasses pass through the media and retained within the media, or contained within the oil particles. Oil collected around the opening to the sump will generally drain down into the sump due to the pressure of the incoming crankcase emissions. The bottom of the housing could have a slight downward taper toward the sump to facilitate oil flow into the sump.

The collected oil then passes downwardly by gravity through the drain port in the sump, where it can be returned to the engine. The substantially oil and emission-particulate-free gases then continue to pass through the media, through the aperture(s) in the support device, and out through the outlet port in the housing, where the gasses can then be directed to a turbocharger, to atmosphere, to or other appropriate location. In a closed crankcase application, this will prevent oil and contaminants from entering the turbocharger which would cause damage and premature wear to the turbo components. In an open crankcase application, the device will reduce the amount of oil and contaminants which would be exposed to the atmosphere. The result is a cleaner burning and more efficient engine that will benefit the environment.

Should the filter media become spent, the filter can be easily removed by removing the hoses at the inlet and outlet ports, removing the housing, and replacing the filter with a new housing and fresh element.

The filter of the present invention could also be used as an impactor or pre-separator to remove oil droplets from engine crankcase emissions/particulates during operation.

The principles, preferred embodiments and modes of operation of the present invention have been described in the foregoing specification. The invention which is intended to be protected herein should not, however, be construed as limited to the particular form described as it is to be regarded as illustrative rather than restrictive. Variations and changes may be made by those skilled in the art without departing from the scope and spirit of the invention as set forth in the appended claims.

What is claimed is:

1. A filter for removing liquid contaminants from an emissions stream, comprising:
a housing defining an internal chamber and including i) an upstream inlet port in the housing for directing the emissions stream into one axial end of the chamber, and ii) a downstream outlet port in the housing for directing the emissions stream out of another axial end of the chamber, and iii) a drain port in the chamber intermediate the inlet and outlet ports for directing liquid contaminants in the fluid emissions stream outwardly from the chamber;
filter media disposed in the chamber for separating liquid contaminants from the emissions stream, the filter media being insertable into the chamber through the inlet port, and
a support device supporting a downstream end of the filter media at a predetermined axial location within the chamber, the support device including a frame fixed within the housing downstream from the drain port and an aperture, the support device preventing liquid contaminants from migrating downstream along the walls of the housing and allowing a contaminant free emissions stream to pass through the aperture and downstream to the outlet port, wherein the liquid contaminants in the emissions stream agglomerate in the media and flow outwardly from the drain port.

2. The filter as in claim 1, wherein the housing is a unitary, molded component.

3. The filter as in claim 1, wherein the filter media is an expanded aluminum media.

4. The filter as in claim 1, wherein the frame of the support device has a continuous circular outer diameter, and a star-shaped inner geometry defining a central aperture.

5. The filter as in claim 1, wherein the housing includes a sump between the support device and the inlet port, and the drain port is formed in the sump.
